(19) United States
(12) Patent Application Publication
(10) Pub. No.: US 2010/0131265 A1
(43) Pub. Date: May 27, 2010

(54) Method, Apparatus and Computer Program Product for Providing Context Aware Queries in a Network

(75) Inventors: Zhigang Liu, Sunnyvale, CA (US); Peter Boda, Palo Alto, CA (US)

Correspondence Address: DITTHAVONG MORI & STEINER, P.C., 918 Prince Street, Alexandria, VA, 22314, US

(73) Assignee: Nokia Corporation

(21) Appl. No.: 12/277,891

(22) Filed: Nov. 25, 2008

(51) Int. Cl. G06F 17/27

(52) U.S. Cl. 704/9

(57) ABSTRACT

A method for providing context aware queries in a network may include receiving a question directed to a question answering service from an originating node, routing the question to one or more candidate nodes selected based at least in part on context information associated with the question, receiving an answer to the question from at least one of the candidate nodes, and providing the answer to the originating node based at least in part on result parameters associated with the originating node. An apparatus and computer program product corresponding to the method are also provided.

### TECHNOLOGICAL FIELD

Embodiments of the present invention relate generally to information service technology and, more particularly, relate to a method, apparatus and computer program product for providing context aware queries in a network such as, for example, a social network.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to increase the ease of information transfer and convenience to users relates to the provision of services to users of electronic devices. Given the popularity of the Internet, and the vast sources of information that are accessible using the Internet, various Internet services have evolved to provide users with information from a plurality of different sources. In this regard, for example, Internet services have evolved for use with personal computers (PCs) in order to provide such devices with a vast array of services to enable access to information.

The information a particular user may desire to access can be obtained in a number of ways. In some cases, users may simply follow a series of known or discovered links on various web pages to desirable information that may be found on other web pages. In other cases, users may search for the information they desire by providing a search term or query. In still other cases, the user may pose a question for which the user would like to have an answer. With respect to the provision of questions as a mechanism for accessing information, several Internet services (e.g., Google search, Yahoo Answers, AskJeeves, answers.com, and/or the like) may be queried by users for answers to questions. However, while such services may be useful in providing answers to questions regarding static and/or historical based questions, they may not be well suited for providing answers to many questions related to dynamic, real-time, or recent information.

Accordingly, it may be desirable to provide an improved mechanism for handling queries in a network.

### BRIEF SUMMARY OF SOME EXAMPLES OF THE INVENTION

A method, apparatus and computer program product are therefore provided enable the provision of a mechanism for handling context aware queries in a network. In some exemplary embodiments, a network such as a social network and the connections established therein may be employed, at least in part, for the routing of questions to individuals identified as likely candidates for having answers to questions posed by other users. As such, some exemplary embodiments of the invention may provide for an improved capability for users to receive information they desire in a real-time or near real-time fashion. Furthermore, some embodiments of the present invention may be employed in connection with mobile devices so that, context clues may be utilized for routing questions. In some cases, question routing may be completely anonymous or initially anonymous until one party requests or permits identification of the other party. In an exemplary embodiment, historical information may also be used to identify potential answer providers. Accordingly, for example, in cases when no answer can be given in a first attempt, e.g., no matching node found, system constraints may be relaxed slightly so that the system can find a node that was, for example, within two days from now in a given location and might provide an answer. Thus a graceful or flexible approach is provided instead of providing no answer.

In an exemplary embodiment, a method of providing context aware queries in a network is provided. The method may include receiving a question directed to a question answering service from an originating node, routing the question to one or more candidate nodes selected based at least in part on context information associated with the question, receiving an answer to the question from at least one of the candidate nodes, and providing the answer, or a summary or processed digest or edited version of it, to the originating node based at least in part on result parameters associated with the originating node.

In another exemplary embodiment, a computer program product for providing context aware queries in a network is provided. The computer program product includes at least one computer-readable storage medium having computer-executable program code instructions stored therein. The computer-executable program code instructions may include program code instructions for receiving a question directed to a question answering service from an originating node, routing the question to one or more candidate nodes selected based at least in part on context information associated with the question, receiving an answer to the question from at least one of the candidate nodes, and providing the answer to the originating node based at least in part on result parameters associated with the originating node.

In another exemplary embodiment, an apparatus for providing context aware queries in a network is provided. The apparatus may include a processor. The processor may be configured to receive a question directed to a question answering service from an originating node, route the question to one or more candidate nodes selected based at least in part on context information associated with the question, receive an answer to the question from at least one of the candidate nodes, and provide the answer to the originating node based at least in part on result parameters associated with the originating node.

In yet another exemplary embodiment, an apparatus for providing context aware queries in a network is provided. The apparatus may include means for receiving a question directed to a question answering service from an originating node, means for routing the question to one or more candidate nodes selected based at least in part on context information associated with the question, means for receiving an answer to the question from at least one of the candidate nodes, and means for providing the answer to the originating node based at least in part on result parameters associated with the originating node.

Embodiments of the invention may provide a method, apparatus and computer program product for employment, for example, in mobile environments. As a result, for example, mobile device users may enjoy an improved capability for obtaining information via their respective computing devices in a dynamic and context-aware way.

### BRIEF DESCRIPTION OF THE SEVERAL VIEWS OF THE DRAWING(S)

Having thus described some embodiments of the invention in general terms, reference will now be made to the accompanying drawings, which are not necessarily drawn to scale, and wherein:

FIG. 1 illustrates one example of a communication system according to an exemplary embodiment of the present invention;

FIG. 2 illustrates a schematic block diagram of an apparatus for providing context queries according to an exemplary embodiment of the present invention;

FIG. 3 illustrates a block diagram of a mobile terminal according to an exemplary embodiment of the present invention; and

FIG. 4 is a flowchart according to an exemplary method for providing context queries according to an exemplary embodiment of the present invention.

### DETAILED DESCRIPTION OF SOME EMBODIMENTS OF THE INVENTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the present invention.

Given the ubiquitous nature of mobile terminals, such as mobile phones and numerous other mobile electronic devices, communication networks including peer-to-peer (P2P) networks and others are becoming more common for sharing content between individuals in social groups or social networks. These social networks may center on a group of friends, relatives, co-workers, business associates, or people who share a common interest. Each individual (i.e., node) within a social network may be a peer within the P2P network or a member of a service associated with the social network. In some cases, each node may be connected to other nodes such as individuals who are members of or have been invited to join the social network. As such, although any particular node may generally communicate with a given group of other nodes within the social network, each of the other nodes may subsequently communicate with yet other nodes. Accordingly, within a social network, each node may be defined in terms of a degree of separation from each other node. For example, first degree contacts may include contacts to which a particular node directly communicates (e.g., friends, relatives, co-workers, and/or the like that may be included in the contact list of the particular node) and second degree contacts may include contacts who directly communicate with a first degree contact of the particular node, but not with the particular node (e.g., individuals in the contact lists of the first degree contacts). Additional degrees of separation between nodes may all be considered together to form a vast hierarchical network of interconnected nodes.

Some embodiments of the present invention may be practiced in the context of a social network. However, other embodiments could be practiced in other networks that are not necessarily social networks. For example, an alternative exemplary embodiment may be practiced in the context of a subscription based network service in which various subscribers to the service may participate as providers of answers to questions and/or sources for questions at different times. In yet another example embodiment, an embodiment may be practiced around a business model such that entities (e.g., certain people or a network of people or a small business) may plug into the overall architecture in order to provide professional answers, like doing answering as their job as a sort of “virtual helpdesk” or concierge service. In an exemplary case, a pricing model or ad-supported model may be implemented. Also, a network of potential users might be a network of work mates. In some other embodiments, providers of answers and/or sources for questions may be anonymous. However, in other embodiments, the individuals asking questions and providing answers may be placed in direct communication with each other (e.g., via a voice call), for example, if the parties, the asker and the answerer indicate so.

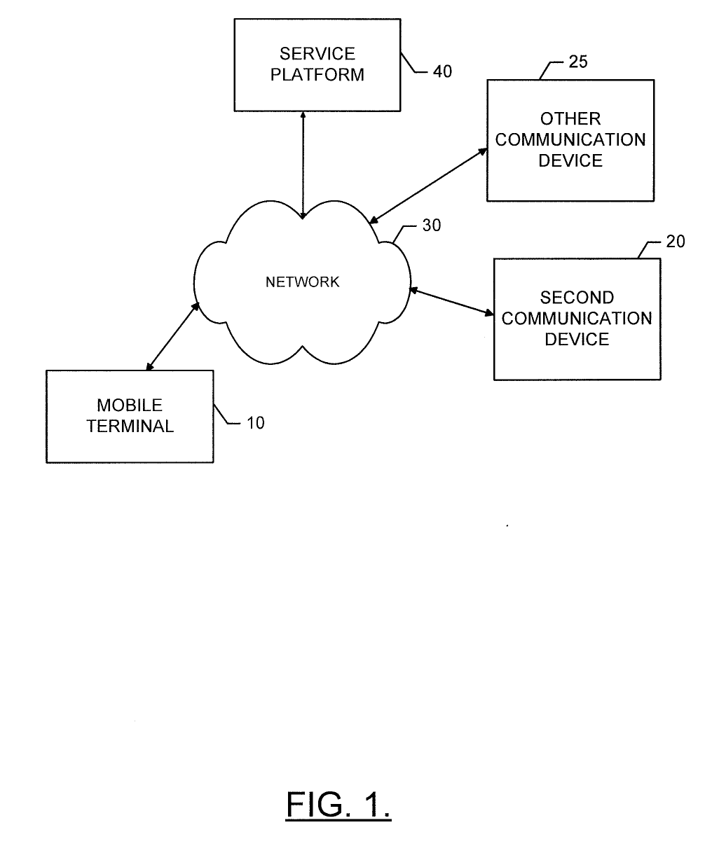

FIG. 1 illustrates a generic system diagram in which a device such as a mobile terminal 10, which may benefit from embodiments of the present invention, is shown in an exemplary communication environment. As shown in FIG. 1, an embodiment of a system in accordance with an example embodiment of the present invention may include a first communication device (e.g., mobile terminal 10) and a second communication device 20 capable of communication with each other via a network 30. In some cases, embodiments of the present invention may further include one or more additional communication devices (e.g., other communication device 25, which may be an example to illustrate potential multiplicity with respect to instances of other devices like the second communication device 20) and one or more network devices such as a service platform 40 with which the mobile terminal 10 (and possibly also the second communication device 20) may communicate to provide, request and/or receive information. In some embodiments, not all systems that employ embodiments of the present invention may comprise all the devices illustrated and/or described herein. While several embodiments of the mobile terminal 10 may be illustrated and hereinafter described for purposes of example, other types of mobile terminals, such as portable digital assistants (PDAs), pagers, mobile televisions, mobile telephones, gaming devices, laptop computers, cameras, camera phones, video recorders, audio/video player, radio, GPS devices, or any combination of the aforementioned, and other types of voice and text communications systems, can readily employ embodiments of the present invention. Additionally, various devices can provide via their interface or an additional interface provided e.g. by a phone, means to ask questions related to the device, like a Wii game device where the domain of questions may be related e.g. to usage, help, setting up, etc. Furthermore, devices that are not mobile may also readily employ embodiments of the present invention.

The network 30 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like. In some embodiments, the network 30 may be a P2P network.

One or more communication terminals such as the mobile terminal 10 and the second communication device 20 may be in communication with each other via the network 30 and each may include an antenna or antennas for transmitting signals to and for receiving signals from a base site, which could be, for example a base station that is a part of one or more cellular or mobile networks or an access point that may be coupled to a data network, such as a local area network (LAN), a metropolitan area network (MAN), and/or a wide area network (WAN), such as the Internet. In turn, other devices such as processing elements (e.g., personal computers, server computers or the like) may be coupled to the mobile terminal 10 and the second communication device 20 via the network 30. By directly or indirectly connecting the mobile terminal 10 and the second communication device 20 and other devices to the network 30, the mobile terminal 10 and the second communication device 20 may be enabled to communicate with the other devices or each other, for example, according to numerous communication protocols including Hypertext Transfer Protocol (HTTP) and/or the like, to thereby carry out various communication or other functions of the mobile terminal 10 and the second communication device 20, respectively.

Furthermore, although not shown in FIG. 1, the mobile terminal 10 and the second communication device 20 may communicate in accordance with, for example, radio frequency (RF), Bluetooth (BT), Infrared (IR) or any of a number of different wireline or wireless communication techniques, including LAN, wireless LAN (WLAN), Worldwide Interoperability for Microwave Access (WiMAX), WiFi, ultra-wide band (UWB), Wibree techniques and/or the like. As such, the mobile terminal 10 and the second communication device 20 may be enabled to communicate with the network 30 and each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as WLAN, WiMAX, and/or the like and fixed access mechanisms such as digital subscriber line (DSL), cable modems, Ethernet and/or the like.

In an example embodiment, the service platform 40 may be a device or node such as a server or other processing element. The service platform 40 may have any number of functions or associations with various services. As such, for example, the service platform 40 may be a platform such as a dedicated server (or server bank) associated with a particular information source or service (e.g., a social network service and/or a contextual query routing service), or the service platform 40 may be a backend server associated with one or more other functions or services. As such, the service platform 40 may represent a plurality of different services or information sources. The functionality of the service platform 40 may be provided by hardware and/or software components configured to operate in accordance with known techniques for the provision of information to users of communication devices. However, some of the functionality provided by the service platform 40 may be information provided in accordance with embodiments of the present invention.

In an exemplary embodiment, the service platform 40 and the second communication device 20 may each represent sources for information that may be provided to the mobile terminal 10 in accordance with embodiments of the present invention. As such, for example, in response to the provision of a question (e.g., a query) from the mobile terminal 10, the service platform 40 and/or the second communication device 20 (or one of the multiple other devices in communication with the network as exemplified by the other communication device 25) may be utilized to provide information to the mobile terminal 10 that is responsive to or an answer to the question provided.

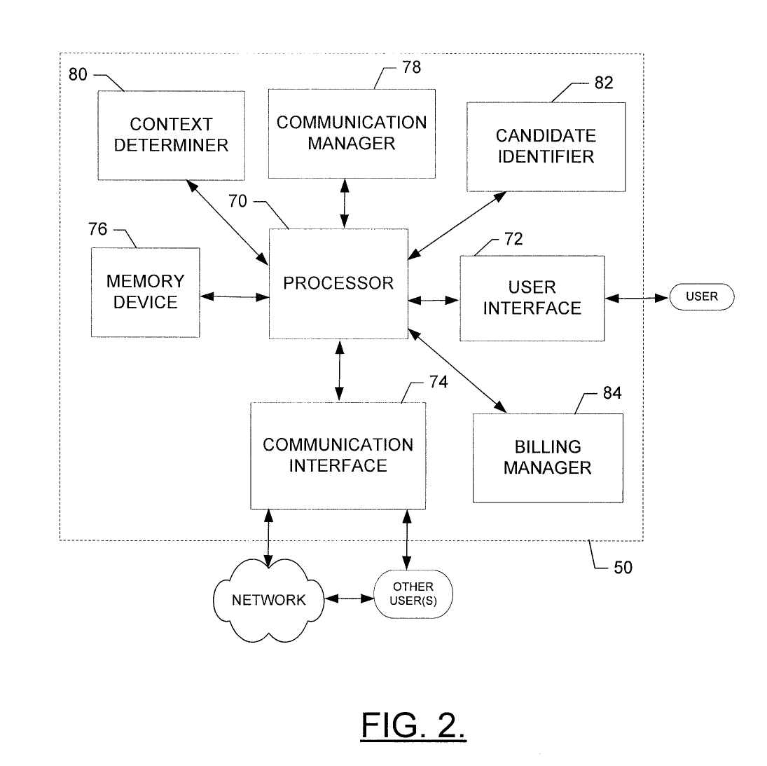

FIG. 2 illustrates a schematic block diagram of an apparatus for enabling the provision of context query management according to an exemplary embodiment of the present invention. An exemplary embodiment of the invention will now be described with reference to FIG. 2, in which certain elements of an apparatus 50 for providing context query management are displayed. The apparatus 50 of FIG. 2 may be employed, for example, on the service platform 40. However, the apparatus 50 may alternatively be embodied at a variety of other devices, both mobile and fixed (such as, for example, any of the devices listed above). In some cases, embodiments may be employed on a combination of devices. Accordingly, some embodiments of the present invention may be embodied wholly at a single device (e.g., the service platform 40), by a plurality of devices in a distributed fashion (e.g., on one or a plurality of devices in a P2P network) or by devices in a client/server relationship (e.g., the mobile terminal 10 and the service platform 40). Furthermore, it should be noted that the devices or elements described below may not be mandatory and thus some may be omitted in certain embodiments. In an exemplary embodiment, the service platform 40 may receive a question from the mobile terminal 10 related to a question answering service and may determine to which of many potential candidate nodes (e.g., the second communication device 20) the question is to be forwarded.

Referring now to FIG. 2, an apparatus for providing context query management is provided. The apparatus 50 may include or otherwise be in communication with a processor 70, a user interface 72, a communication interface 74 and a memory device 76. The memory device 76 may include, for example, volatile and/or non-volatile memory. The memory device 76 may be configured to store information, data, applications, instructions or the like, or to store history data to help the process of answer providing for enabling the apparatus to carry out various functions in accordance with exemplary embodiments of the present invention. For example, the memory device 76 could be configured to buffer input data for processing by the processor 70. Additionally or alternatively, the memory device 76 could be configured to store instructions for execution by the processor 70. As yet another alternative, the memory device 76 may be one of a plurality of databases that store information and/or media content.

The processor 70 may be embodied in a number of different ways. For example, the processor 70 may be embodied as various processing means such as a processing element, a coprocessor, a controller or various other processing devices including integrated circuits such as, for example, an ASIC (application specific integrated circuit), an FPGA (field programmable gate array), a hardware accelerator, or the like. In an exemplary embodiment, the processor 70 may be configured to execute instructions stored in the memory device 76 or otherwise accessible to the processor 70.

Meanwhile, the communication interface 74 may be any means such as a device or circuitry embodied in either hardware, software, or a combination of hardware and software that is configured to receive and/or transmit data from/to a network and/or any other device or module in communication with the apparatus. In this regard, the communication interface 74 may include, for example, an antenna (or multiple antennas) and supporting hardware and/or software for enabling communications with a wireless communication network. In fixed environments, the communication interface 74 may alternatively or also support wired communication. As such, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, a microphone, a speaker, or other input/output mechanisms. In an exemplary embodiment in which the apparatus is embodied as a server or some other network devices, the user interface 72 may be limited, or eliminated. However, in an embodiment in which the apparatus is embodied at a communication device (e.g., the mobile terminal 10), the user interface 72 may include, among other devices or elements, any or all of a speaker, a microphone, a display, and a keyboard or the like.

In an exemplary embodiment, the processor 70 may be embodied as, include or otherwise control a communication manager 78, a context determiner 80, a candidate identifier 82 and a billing manager 84. As such, the communication manager 78, the context determiner 80, the candidate identifier 82 and the billing manager 84 may in some cases each be separate devices, modules, or functional elements. However, in other embodiments, some or all of the communication manager 78, the context determiner 80, the candidate identifier 82 and the billing manager 84 may be embodied within a single device, module, or functional element, such as the processor 70. The communication manager 78, the context determiner 80, the candidate identifier 82 and the billing manager 84 may each be any means such as a device or circuitry embodied in hardware, software or a combination of hardware and software (e.g., processor 70 operating under software control) that is configured to perform the corresponding functions of the communication manager 78, the context determiner, the candidate identifier 82 and the billing manager 84, respectively, as described below. In some embodiments, communication between any or all of the communication manager 78, the context determiner 80, the candidate identifier 82 and the billing manager 84 may be conducted via the processor 70. However, some or all of the communication manager 78, the context determiner 80, the candidate identifier 82 and the billing manager 84 may alternatively be in direct communication with each other.

The communication manager 78 may be configured to handle communications related to receiving questions (e.g., from a user of the mobile terminal 10) from a device providing a query and routing received questions to one or more candidates as determined by the candidate identifier 82. In response to one or more of the candidates identified by the candidate identifier 82 providing a response to a question routed thereto, the communication manager 78 may be further configured to provide the response to the question (e.g., answer received from the second communication device 20) back to the device providing the query (e.g., the mobile terminal 10 acting as an originating node). In some embodiments, multiple parties may receive the question and the communication manager 78 may send the first received answer, some or all of the answers separately or in a composite fashion, or selected answers based on agreement between the answers, relationship proximity to the questioner, a ranking of the answerer, or other factors. In an exemplary embodiment, the communication manager 78 may route the query to candidates identified by the candidate identifier 82 based on context information determined by the context determiner 80. Furthermore, in embodiments in which the billing manager 84 is employed, the communication manager 78 may communicate with the billing manager 84 to determine billing, if any, for the user providing the query. In an example embodiment, the billing manager 84 may be set so that questions addressed to the first level social network, e.g. people in a contact list of the device asking the question, are free of charge or at a relatively low rate, but if the user indicates that a deeper and wider coverage is needed, desired or permissible, then a charge (or higher rate) may be imposed. Thus, questions may be distributed up to any desirable degree of separation, but the price per question may increase accordingly.

The context determiner 80 may be configured to determine contextual information with respect to questions received by the communications manager 78. Context is generally defined as any information that can be used to characterize the situation of an entity. An entity may be a person, place or object (e.g., the user or the user's mobile terminal) that is considered relevant to an interaction between a user and an application, including the user and the application themselves. Accordingly, a system may be considered context aware if the system uses context information to provide relevant information and/or services to the user such as where relevancy depends on the user's task.

In some embodiments, the context determiner 80 may be a context aware device or element configured to request context information or provide interface elements aimed at acquiring context information from the user. For example, the context determiner 80 may be configured to generate various domains, fields, user interface elements and/or the like designed to enable the user to enter information that may, in addition to providing text associated with the query, provide context related information. The domains, fields, user interface elements and/or the like may be text entry based, predetermined selectable options, or customizable options that may change dependent upon user criteria (e.g., subscription level to the service, location, settings or preferences, etc.). As an example, the context determiner 80 may have a mechanism by which the user may enter the city, country, region, or specific location to which a question pertains. E.g. via a graphical UI, it could be defined that Location=NYC or Helsinki and then a free from text input may provide means to enter the question itself. Alternatively or additionally, the system may offer all possible values for the Location, knowing where all other users are at the moment or were within a predetermined period of time (e.g., the past two days). As another example, various selectable common classifications for questions may be provided (e.g., weather conditions, dining, night life, tourism, driving conditions, crowd conditions, best route, recommendations, and/or many others). The information provided by the user may then be utilized to extract context information for provision to the candidate identifier 82.

In an alternative embodiment, the context determiner 80 may be configured to extract information from communications received from the user providing the question (e.g., the mobile terminal 10). As such, for example, the context may be determined from the status of applications on the mobile terminal 10, the location of the mobile terminal 10, a determination of a predefined association for a particular object, or any other mechanism for discovering the types of context information described herein. For example, the context determiner 80 may request or otherwise acquire information regarding a location of the mobile terminal 10 (e.g., from the mobile terminal 10 or from a network position determining entity) and/or other communication devices. Alternatively or additionally, the context determiner 80 may parse (e.g., applying some natural language understanding technology either on the device or on the server side or implemented on a distributed fashion) the query itself to determine if context information is provided within the text of the query. For example, if a query asks whether it is currently windy in Helsinki, the context determiner 80 may determine a location context corresponding to Helsinki and a question classification context of a weather related question based on the reference to wind conditions. Context information may also be determined, for example, based on a determination of various context parameters that may be accessed by the context determiner 50 in order to determine context of subscribers to the service (e.g., of the second communication device 20 and other communication devices).

Context parameters may include parameters related to, for example, environmental context, social context, spatio-temporal context, task context, terminal context, service context, access context, and/or the like, or combinations thereof. Environmental context may describe the entities around the user (e.g., the user of an electronic device) and the environment in which the user and the user's device are located. Social context may include information about relationships with other individuals (e.g., friends, relatives, co-workers, etc.) or social situations like being on a meeting, occupied, travelling, driving, etc. Spatio-temporal context may define the user's location (e.g., physical or geographical location) in the real world at a certain point in time. Task context may describe information related to on-going tasks. Task context may be determined, for example, from calendar applications or the execution of other applications at a particular time. Terminal context may be related to or descriptive of the status and/or capabilities of the user's device. Service context may relate to or be descriptive of services that are available at a particular location or based on the subscription level of the user. Access context may describe the status of network connectivity. Other context parameters could also be included and those listed above are merely examples. In an exemplary embodiment, context parameters relating to members of the social network and/or subscribers to a question answering service may be reported to the context determiner 80 or a repository accessible to the context determiner either continuously, when requested, or at random or predetermined intervals. Thus, the context determiner 80 can report on context information for any user and/or for questions originating from any user, at any given time.

After the context determiner 80 has determined the context information, the context determiner 80 may communicate the context information to the candidate identifier 82. The candidate identifier 82 may be configured to identify candidates that may be likely to answer, or be able to answer, a particular question based on the context information. In some cases, a qualitative assessment may also be included based on each candidate's history for answering questions. In this regard, for example, the context determiner 80 may be configured to determine context information corresponding to the question asked and/or candidate users and the candidate identifier 82 may be configured to use the context information to identify one or more other users (e.g., the user of the second communication device 20 and/or one or more users of other communication devices) as candidate users that may, based on the context information, have information or be situated to obtain information useful for answering the question asked. For example, in relation to the question above regarding whether it is windy in Helsinki, the candidate identifier 82 may be configured to determine which other users (e.g., users that are members of the social network and/or subscribers to the question answering service) are in Helsinki and in some cases, which candidates are outside currently and may be able to give an accurate report. In an example graceful or flexible implementation, if no one was found matching the contextual criteria, the system could take historic data and find someone who had been e.g. within the past 2 days in Helsinki and might be able to provide an answer. An identity of such candidates may then be provided to the communication manager 78 to enable the communication manager 78 to send the question to the identified candidates.

In some embodiments, the candidate identifier 82 may be configured to identify candidates based on matching question and corresponding candidate user (or node) context over one or more parameters. As such, for example, a plurality of users may be ranked, based on a particular question, with respect to a number of features of the particular question for which each respective user has correlating context information. The user (or a predetermined number of users) having the highest ranking may then be identified as a candidate user and the candidate user's candidate identifier may be communicated to the communication manager 78.

In an exemplary embodiment, the candidate identifier 78 may be further configured to determine the loading (e.g., with respect to answering questions or other network activities) of the candidate users and modify selection of particular candidates for identification to the communication manager 78 based on the loading information. Thus, nodes that are heavily loaded with responding to questions may have questions steered away in order to balance loading with less heavily loaded nodes. However, in some embodiments, information relating to the frequency and/or quality (e.g., in terms of speed or accuracy) of response of any particular node may also impact candidate scoring. In this regard, for example, nodes that are more likely to actually provide an answer, based on past response frequency, may be scored higher or otherwise biased toward receiving questions for which they may be able to provide an answer (assuming the current loading of the node permits provision of the answer).

In an exemplary embodiment, the communication manager 78 may be configured to pass questions and answers between participants of the service in an anonymous fashion. As such, for example, when the communication manager 78 sends a question to one or more identified candidate nodes, the node from which the question originated may not be identified to the candidate nodes. Similarly, when one or more answers to the question are received by the communication manager 78, the communication manager 78 may send one or more of the answers to the node from which the question originated without identifying the candidate node that provided the response. In an example embodiment, the system may generate credits for users giving highly rated and/or frequent answers. These credits can be later used for purposes such as promotion, redemption for merchandise, etc. The system and service provider can bring in vendors and advertisers and these credits might be used via these businesses.

In some alternative embodiments, the communication manager 78 may provide identities of the communicating parties in certain situations. For example, participants such as members of the social network or subscribers to the service may provide settings or user preferences to indicate whether they would like to be identified to other parties when acting as a questioner and/or an answerer. In some cases, the participants may specify an alias, nickname, actual name, telephone number, email address, or other identifying information to be provided in certain situations. Thus, for example, when answering a question, the answerer may be enabled to indicate whether the answerer is willing to entertain follow-up questions via email, short message service (SMS), voice call, or other modes of communication. This indication may be universally provided when certain conditions defined in settings or preferences of the corresponding answerer have been met, may be provided by the answerer along with an answer to a question, or may be solicited from answerers by the communication manager 78 when an answer is received. Also, in some embodiments, the degree of separation between the question originator and the potential recipient of the question may be indicated. Human interest or curiosity may be an important factor and one may wish to trigger establishment of a live connection, try to figure out individuals separated from oneself by a particular number of degrees or try to determine common persons known by oneself and other parties.

Historical information may also be employed in connection with embodiments of the present invention. In an exemplary embodiment, historical information may include a record of question and answer exchanges for a particular transaction. As such, historical answers to questions may be stored in a repository such as a database (e.g., the memory device 76) in communication with the communication manager 78. The answers may be stored along with context information determined for the question. The answers may also be stored along with information identifying the time and/or date the answer was provided and possibly also with information identifying the questioner and/or answerer. Stored answers may also be considered for provision in response to a particular question under certain circumstances. For example, if a new question is received at the communication manager 78 that is a nearly identical question to a previous question asked by another subscriber, the communication manager 78 may provide the same answer to the new question that was provided for the previous question. In some cases, context information regarding the new and previous questions may be matched prior to issuing the previous answer to avoid providing the wrong answer due to ambiguity in the question that could be resolved based on context. For example, if two questions are asked in which each question inquires as to what the weather is like today in Paris, the context associated with each may indicate that one question relates to Paris, Tex., while the other relates to Paris, France. Thus, when question content and context match, consideration may be given to providing a previous answer. In some embodiments, answers may be valid for a predetermined time during which they may be reused if a similar question is asked. The predetermined time may vary dependent upon the class of question (e.g., a traffic related question may be valid for several minutes to an hour, while a weather related question may be valid for several hours or even all day).

In an example embodiment, any information, may it be contextual by definition or not, or any combination of information thereof, may be used in providing or assisting with the provision of more flexible or graceful answers. For example, historical information may also include information that may indicate past locations for users or other contextual information that can be used to provide answers in situations for which no answer may otherwise be provided due to no one initially appearing to be qualified to answer the question. Past locations of various different users may be useful in identifying candidate users to which questions may be posed. Thus, for example, if a question is asked regarding a specific location and no subscribers are currently in the location, historical information may indicate the subscribers who were most recently in the location, as they may be the best people to ask. Historical information may therefore serve as a backup to current information in situations where current information cannot be provided, or cannot be provided within a time period required by the questioner's subscription level or requested response time. Thus, for example, if the questioner requests an answer to a question within five minutes and the communication manager 78 is not able to identify candidates or receive a response from candidates within the requested time period, the communication manager 78 may provide a historical response prior to expiration of the requested time period.

The billing manager 84 may be configured to provide billing services for subscribers to the question answering service when such services are utilized. In this regard, for example, the billing manager 84 may provide users with a mechanism by which to tailor services to their respective needs, desires, budgetary constraints and/or the like. As such, for example, the billing manager 84 may establish a billing and pricing model by enabling users to tune certain system parameters such as real-time capability and coverage of potential answerers to their personal preferences. In an exemplary embodiment, different subscription levels may be provided to users and each subscription level may have corresponding defined levels of service. Thus, for example, on lower subscription levels only first degree contacts may be covered and/or a certain degree of delay in response may be provided or accepted. However, for higher level subscriptions, a much larger scope of potential answerers (e.g., such as all subscribers, including my primary contacts, the contacts in the contact lists of my contacts, etc.) may be reachable and/or a higher degree of real-time response may be provided. In some embodiments, users may modify system parameters and be billed accordingly on a per-question basis. As such, for example, while providing the question the questioner may also be asked or enabled to provide information indicating the desired scope of potential answerers and/or the degree of real-time response desired. In some instances, the user may get a preliminary quote from the billing manager 84 as to a predicted scope of coverage and corresponding time within which the question is likely to be answered. Pricing may be arranged in many different ways. For example, directing questions to first degree target nodes may not cost anything (or may have relatively low rates associated therewith). Meanwhile, if the user wants a faster and/or more widely distributed answer, then parameters may be set so that more than a predetermined increased amount (e.g., 10% relative to the default nodes selected by the system from the potentially matching nodes) of users may be addressed with the question and the candidates for responding may extend beyond the first degree. As another example, answers can be rated and good repliers may build up credits that can be used for new questions for a wider/deeper audience, or for other things.

In an exemplary embodiment, the billing manager 84 may also consider other factors with respect to billing and pricing. For example, subscribers may be given lower rates, subscription upgrades, free inquiries or other benefits based on frequency and/or quality of answers provided. As such, since the service incorporates the collective wisdom and knowledge of the participants in the system, those who benefit the service by sharing knowledge more willingly, quickly or frequently may be given incentives to continue to enrich the system. Quality ratings may be determined by feedback that the communication manager 78 may be configured to solicit from questioners to rate the answer provided for their respective questions. Furthermore, the communication manager 78 may track the responsiveness of each candidate node to questions (e.g., the average frequency with which a candidate node responds to or ignores questions posed to the user, the average speed with which the candidate node responds relative to receiving the question). In some embodiments, subscribers may indicate times of availability to answer questions. As such, for example, the billing manager could also consider factors such as responsiveness and/or availability of subscribers in determining billing and pricing. Moreover, as indicated above, such factors may also impact which nodes are selected as candidate nodes for any particular question.

In an exemplary embodiment, the communication manager 78 may provide routing services with regard to answers to questions based on result parameters associated with the user. As such, for example, the result parameters associated with a particular questioner may define the audience to which questions may be posed and/or response time for receiving answers. In other words, for example, the user may dictate that the communication manager 78 provide routing services within a predetermined period of time (e.g., within a defined response time). The response time (and/or audience) allowed for any particular question may be based on the subscription level or other indications received from the questioner related to a desired cost for the corresponding question. For example, if the questioner desires real-time or near real-time service, which may be limited by definition to service provided within about a few minutes or a few dozen seconds, the questioner may pay higher rates than a question for which a response is desired within one or a few hours. As such, the user may choose result parameters that govern coverage and speed and determine cost.

In an exemplary embodiment, operation of embodiments of the present application could take many forms. For example, a person may ask a question by sending a message (e.g., via email, SMS, text message, a service specific message or any other suitable communication mechanism) to the service platform 40 (e.g., directly or through a web browser). In one simple form, the user may type the whole question in, like a text message. In a more sophisticated implementation, the user may pre-select the domain of the question (e.g., the location) and then type in the essence or content of the question. Alternatively, as discussed above, the system may offer a listing of valid domains, locations, etc., based on collected knowledge determined from the online users. For instance, listing all possible locations where users are currently located (e.g., on a city level). Embodiments may also indicate situations in which no one is in a given city about which a question is posed, but someone was there within a couple of days in order to evaluate whether provision of a historical answer may be appropriate. In some cases, embodiments may be configured to indicate when listing domains, locations, etc., how far in the social network the answer might be found (e.g., at what degree of separation from the questioner), which could impact price.

In an alternative exemplary embodiment, the apparatus 50 may receive a question and search its contextual database (e.g., for current and past locations, user profiles, relationship, history of past answers, etc.) to find good candidates who are likely to provide the best answers to the question. Candidate selection can also be based on load balancing. In some cases, depending on applications and configurations, the service platform 40 may be configured to provide two types of communication channels. One channel may be employed to connect the questioner and responder with a voice call, but hide the identity of both, while the other channel may be employed to relay anonymous messages back and forth. In some embodiments, as described above, messages from a question and answer session may be logged in a database (with or without other activity information) for future candidate selection and answer creation.

In one example use case, a user may want to know if a particular meeting room is available. Although there may be an online reservation system, not everyone may follow the reservations therein. For example, people may reserve a room but not show up or they may grab an empty room without a reservation. Additionally, it may not be unusual for meetings to last longer than expected. Thus, for example, a question regarding the status of the meeting room may be sent to a virtual clipboard (VC) server associated with the service platform 40 that may serve the area in which the meeting is occurring. The VC server may be able to track people's latest locations (e.g. based on Bluetooth tags), and thus the VC server may be able to tell the questioner whether the meeting room is occupied. In addition or alternatively, the VC server may send an SMS on the user's behalf, but without revealing the user's identity, to one, some or all of the people in the meeting room. The SMS may remind the people that someone would like to reserve the room starting in a time indicated by the user and may also alert the user when the room is actually available.

As another example, if it is lunch time and information is desired as to whether a particular restaurant has good food today, the apparatus 50 may route a question seeking the desired information to people at the restaurant. The same may also apply to seat availability and numerous other pieces of information for numerous other reasons. For example, information on public transformation schedules or other items of interest may be the subject of questions.

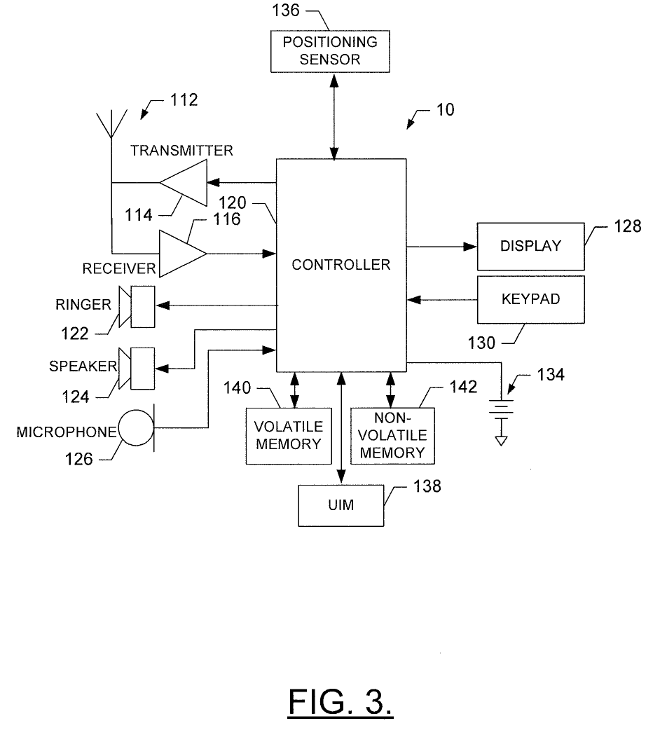

FIG. 3 illustrates a block diagram of a mobile terminal 10 that may benefit from embodiments of the present invention. It should be understood, however, that a mobile terminal as illustrated and hereinafter described is merely illustrative of one type of device that may benefit from embodiments of the present invention and, therefore, should not be taken to limit the scope of embodiments of the present invention.

The mobile terminal 10 may include an antenna 112 (or multiple antennas) in operable communication with a transmitter 114 and a receiver 116. The mobile terminal 10 may further include an apparatus, such as a controller 120 or other processing element, that provides signals to and receives signals from the transmitter 114 and receiver 116, respectively. The signals may include signaling information in accordance with the air interface standard of the applicable cellular system, and/or may also include data corresponding to user speech, received data and/or user generated data. In this regard, the mobile terminal 10 may be capable of operating with one or more air interface standards, communication protocols, modulation types, and access types. By way of illustration, the mobile terminal 10 may be capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with 3.9G wireless communication protocols such as E-UTRAN (evolved-universal terrestrial radio access network), with fourth-generation (4G) wireless communication protocols or the like forthcoming communications modes. As an alternative (or additionally), the mobile terminal 10 may be capable of operating in accordance with non-cellular communication mechanisms. For example, the mobile terminal 10 may be capable of communication in a wireless local area network (WLAN) or other communication networks.

The controller 120 may include circuitry implementing, among others, audio and logic functions of the mobile terminal 10. For example, the controller 120 may comprise a digital signal processor device, a microprocessor device, and various analog to digital converters, digital to analog converters, and/or other support circuits. Control and signal processing functions of the mobile terminal 10 may be allocated between these devices according to their respective capabilities. The controller 120 may also support other functionality for use in encoding, receiving and/or transmitting messages. Further, the controller 120 may include functionality to operate one or more software programs, which may be stored in memory. For example, the controller 120 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as an earphone or speaker 124, a ringer 122, a microphone 126, a display 128, and a user input interface, which may be coupled to the controller 120. The user input interface, which allows the mobile terminal 10 to receive data, may include any of a number of devices allowing the mobile terminal 10 to receive data, such as a keypad 130, a touch display (not shown) or other input device. In embodiments including the keypad 130, the keypad 130 may include numeric (0-9) and related keys (#, *), and other hard and soft keys used for operating the mobile terminal 10. Alternatively, the keypad 30 may include a conventional QWERTY keypad arrangement. The keypad 130 may also include various soft keys with associated functions. In addition, or alternatively, the mobile terminal 10 may include an interface device such as a joystick or other user input interface. The mobile terminal 10 may further include a battery 134, such as a vibrating battery pack, for powering various circuits that are used to operate the mobile terminal 10, as well as optionally providing mechanical vibration as a detectable output.

The mobile terminal 10 may further include a user identity module (UIM) 138, which may generically be referred to as a smart card. The UIM 138 is typically a memory device having a processor built in. The UIM 138 may include, for example, a subscriber identity module (SIM), a universal integrated circuit card (UICC), a universal subscriber identity module (USIM), a removable user identity module (R-UIM), or any other smart card. In addition to the UIM 138, the mobile terminal 10 may be equipped with memory. For example, the mobile terminal 10 may include volatile memory 140 and/or non-volatile memory 142.

In some case, the mobile terminal 10 may further include a positioning sensor 136. The positioning sensor 136 may include, for example, a global positioning system (GPS) sensor, an assisted global positioning system (Assisted-GPS) sensor, etc. However, in one exemplary embodiment, the positioning sensor 136 includes a pedometer or inertial sensor. In this regard, the positioning sensor 136 may be capable of determining a location of the mobile terminal 10, such as, for example, longitudinal and latitudinal directions of the mobile terminal 10, or a position relative to a reference point such as a destination or start point. In some cases, the positioning sensor 136 may include components enabling a determination of mobile terminal 10 position based on triangulation with respect to signals received from various sources or other techniques. Information from the positioning sensor 136 may then, in some cases, be communicated to a memory of the mobile terminal 10 or to another memory device to be stored as a position history or location information. The positioning sensor 136 or a particular device may, for example, provide information on device location (e.g., for the mobile terminal 10, the second communication device 20 and any of a number of other potential candidate devices) for use by the apparatus 50 in determining whether the device should be identified as a candidate node.

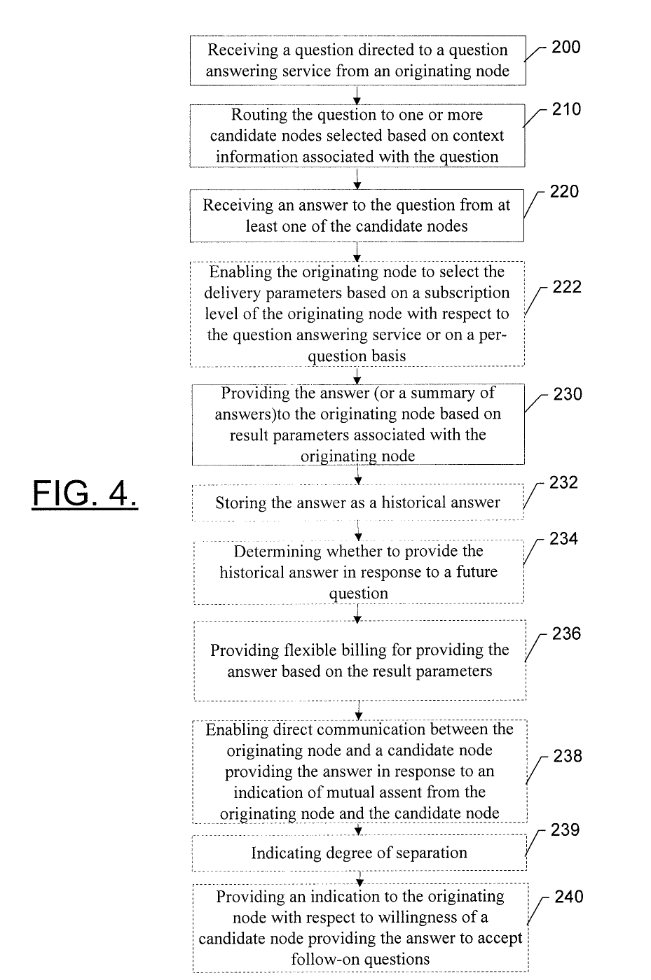

FIG. 4 is a flowchart of a system, method and program product according to some exemplary embodiments of the invention. It will be understood that each block or step of the flowchart, and combinations of blocks in the flowchart, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of a mobile terminal, service platform or other apparatus employing embodiments of the present invention and executed by a processor in the mobile terminal, service platform or other apparatus. As will be appreciated, any such computer program instructions may be loaded onto a computer or other programmable apparatus (i.e., hardware) to produce a machine, such that the instructions which execute on the computer (e.g., via a processor) or other programmable apparatus create means for implementing the functions specified in the flowchart block(s) or step(s). These computer program instructions may also be stored in a computer-readable memory that can direct a computer (e.g., the processor or another computing device) or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

In this regard, one embodiment of a method for providing context queries in a network as illustrated, for example, in FIG. 4 may include receiving a question directed to a question answering service from an originating node at operation 200. The method may further include routing the question to one or more candidate nodes selected based on context information associated with the question at operation 210. At operation 220, an answer to the question may be received from at least one of the candidate nodes. At operation 230, the answer (or a summary of answers) may be provided to the originating node based on result parameters associated with the originating node.

In some embodiments, the method may include further optional operations, examples of which are shown in dashed lines in FIG. 4. Any or all of the optional operations may be performed in combination with each other in various alternative embodiments. As such, the method may further include storing the answer as a historical answer at operation 232 and determining whether to provide the historical answer in response to a future question at operation 234. The determination may be made based on context information. In some situations, a historical answer may be provided when it is determined that no viable candidate is available for providing a real-time answer. In another embodiment, the method may include providing flexible billing for providing the answer based on the result parameters at operation 236. The method may further include enabling the originating node to select the result parameters based on a subscription level of the originating node with respect to the question answering service or on a per-question basis at operation 222. In some embodiments, the method may further include enabling direct communication between the originating node and a candidate node providing the answer in response to an indication of mutual assent from the originating node and the candidate node at operation 238, indicating the degree of separation to the question answerer at operation 239 (e.g., for aiding in establishment of direct communication (e.g., SMS or call) or for satisfying human curiosity) and/or providing an indication to the originating node with respect to willingness of a candidate node providing the answer to accept follow-on questions at operation 240.

In some embodiments, certain ones of the operations above may be modified or further amplified as described below. It should be appreciated that each of the modifications or amplifications below may be included with the operations above either alone or in combination with any others among the features described herein. In this regard, for example, routing the question may include routing the question in response to determining the context information based on question domain or location of interest. In some examples, routing the question may include routing the question to candidates selected subsequent to candidate ranking based on a likelihood that each respective candidate is able to provide an accurate response to the question. In some instances, routing the question may include routing the question without an indication of an identity of the originating node while providing the answer may include providing the answer without an indication of an identity of the at least one of the candidate nodes providing the answer. In an exemplary embodiment, providing the answer may include providing the answer based on result parameters defining a set of nodes to which the question is routable and a response time by which the answer is to be provided.

In an exemplary embodiment, an apparatus for performing the method of FIG. 4 above may comprise a processor (e.g., the processor 70) configured to perform some or each of the operations (200-240) described above. The processor may, for example, be configured to perform the operations (200-240) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 200-240 may comprise, for example, the processor 70, respective ones of the communication manager 78, the context determiner 80, the candidate identifier 82, and the billing manager 84, or an algorithm executed by the processor for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving a question directed to a question answering service from an originating node;
routing the question to one or more candidate nodes selected based at least in part on context information associated with the question;
receiving an answer to the question from at least one of the candidate nodes; and
providing the answer to the originating node based at least in part on result parameters associated with the originating node.

2. The method of claim 1, wherein routing the question comprises routing the question without an indication of an identity of the originating node.

3. The method of claim 1, wherein providing the answer comprises providing the answer without an indication of an identity of the at least one of the candidate nodes providing the answer.

4. The method of claim 1, wherein providing the answer comprises providing the answer based at least in part on result parameters defining a set of nodes to which the question is routable and a response time by which the answer is to be provided.

5. The method of claim 1, further comprising storing the answer as a historical answer and determining whether to provide the historical answer in response to a future question.

6. The method of claim 1, further comprising providing flexible billing for providing the answer based at least in part on the result parameters.

7. The method of claim 1, further comprising enabling the originating node to select the result parameters based at least in part on a subscription level of the originating node with respect to the question answering service or on a per-question basis.

8. The method of claim 1, wherein routing the question comprises routing the question in response to determining the context information based at least in part on question domain or location of interest.

9. The method of claim 1, wherein routing the question comprises routing the question to candidates selected subsequent to candidate ranking based at least in part on a likelihood that each respective candidate is able to provide an accurate response to the question.

10. The method of claim 1, further comprising enabling direct communication between the originating node and a candidate node providing the answer in response to an indication of mutual assent from the originating node and the candidate node.

11. The method of claim 1, further comprising providing an indication to the originating node with respect to willingness of a candidate node providing the answer to accept follow-on questions.

12. A computer program product comprising at least one computer-readable storage medium having computer-executable program code instructions stored therein, the computer-executable program code instruction comprising:
program code instructions for receiving a question directed to a question answering service from an originating node;
program code instructions for routing the question to one or more candidate nodes selected based at least in part on context information associated with the question;
program code instructions for receiving an answer to the question from at least one of the candidate nodes; and
program code instructions for providing the answer to the originating node based at least in part on result parameters associated with the originating node.

13. The computer program product of claim 12, wherein the program code instructions for routing the question include instructions for routing the question without an indication of an identity of the originating node.

14. The computer program product of claim 12, wherein the program code instructions for providing the answer include instructions for providing the answer without an indication of an identity of the at least one of the candidate nodes providing the answer.

15. The computer program product of claim 12, wherein the program code instructions for providing the answer include instructions for providing the answer based at least in part on result parameters defining a set of nodes to which the question is routable and a response time by which the answer is to be provided.

16. The computer program product of claim 12, further comprising program code instructions for storing the answer as a historical answer and determining whether to provide the historical answer in response to a future question.

17. The computer program product of claim 12, further comprising program code instructions for providing flexible billing for providing the answer based at least in part on the result parameters.

18. The computer program product of claim 12, further comprising program code instructions for enabling the originating node to select the result parameters based at least in part on a subscription level of the originating node with respect to the question answering service or on a per-question basis.

19. The computer program product of claim 12, wherein the program code instructions for routing the question include instructions for routing the question in response to determining the context information based at least in part on question domain or location of interest.

20. The computer program product of claim 12, wherein the program code instructions for routing the question include instructions for routing the question to candidates selected subsequent to candidate ranking based at least in part on a likelihood that each respective candidate is able to provide an accurate response to the question.

21. The computer program product of claim 12, further comprising program code instructions for enabling direct communication between the originating node and a candidate node providing the answer in response to an indication of mutual assent from the originating node and the candidate node.

22. The computer program product of claim 12, further comprising program code instructions for providing an indication to the originating node with respect to willingness of a candidate node providing the answer to accept follow-on questions.

23. An apparatus comprising a processor configured to:
receive a question directed to a question answering service from an originating node;
route the question to one or more candidate nodes selected based at least in part on context information associated with the question;
receive an answer to the question from at least one of the candidate nodes; and
provide the answer to the originating node based at least in part on result parameters associated with the originating node.

24. The apparatus of claim 23, wherein the processor is configured to route the question by routing the question without an indication of an identity of the originating node.

25. The apparatus of claim 23, wherein the processor is configured to provide the answer by providing the answer without an indication of an identity of the at least one of the candidate nodes providing the answer.

26. The apparatus of claim 23, wherein the processor is configured to provide the answer by providing the answer based at least in part on result parameters defining a set of nodes to which the question is routable and a response time by which the answer is to be provided.

27. The apparatus of claim 23, wherein the processor is further configured to store the answer as a historical answer and determine whether to provide the historical answer in response to a future question.

28. The apparatus of claim 23, wherein the processor is further configured to provide flexible billing for providing the answer based at least in part on the result parameters.

29. The apparatus of claim 23, wherein the processor is further configured to enable the originating node to select the result parameters based at least in part on a subscription level of the originating node with respect to the question answering service or on a per-question basis.

30. The apparatus of claim 23, wherein the processor is further configured to route the question by routing the question in response to determining the context information based at least in part on question domain or location of interest.

31. The apparatus of claim 23, wherein the processor is configured to route the question by routing the question to candidates selected subsequent to candidate ranking based at least in part on a likelihood that each respective candidate is able to provide an accurate response to the question.

32. The apparatus of claim 23, wherein the processor is further configured to enable direct communication between the originating node and a candidate node providing the answer in response to an indication of mutual assent from the originating node and the candidate node.

33. The apparatus of claim 23, wherein the processor is further configured to provide an indication to the originating node with respect to willingness of a candidate node providing the answer to accept follow-on questions.

34. An apparatus comprising:
means for receiving a question directed to a question answering service from an originating node;
means for routing the question to one or more candidate nodes selected based at least in part on context information associated with the question;
means for receiving an answer to the question from at least one of the candidate nodes; and
means for providing the answer to the originating node based at least in part on result parameters associated with the originating node.

35. The apparatus of claim 34, further comprising storing the answer as a historical answer and determining whether to provide the historical answer in response to a future question.
